(19) United States
(12) Patent Application Publication
(10) Pub. No.: US 2009/0172705 A1
(43) Pub. Date: Jul. 2, 2009

(54) Apparatus and Method for Preservation of USB Keyboard

(75) Inventor: Seong Ho Cheong, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: KINGS INFORMATION & NETWORK, Seoul (KR)

(21) Appl. No.: 12/159,006

(22) PCT Filed: Oct. 16, 2007
(86) PCT No.: PCT/KR2007/005062

§ 371 Date: Oct. 14, 2008

(30) Foreign Application Priority Data
Oct. 16, 2006 (KR) 10-2006-0100366

(51) Int. Cl. G06F 9/44; H04L 9/32

(52) U.S. Cl. 719/321; 726/34

(57) ABSTRACT

Provided are a data security apparatus and method for a USB keyboard. The data security apparatus includes: a USB keyboard security driver for selecting a driver for a USB keyboard from USB devices connected to a personal computer, and replacing a data processing function address in a USB hub driver with a function address of the selected USB keyboard driver to acquire input data input by the USB keyboard; a USB keyboard data processing module for preferentially receiving the input data acquired from the USB keyboard security driver, and processing the input data through analysis, encoding and deletion processes; and a USB keyboard data transfer module for decoding the input data processed by the USB keyboard USB keyboard data processing module and outputting the decoded input data to a user's desired location. Thus, data input by a malicious program from a keyboard in communication with a main body of a personal computer (PC) through USB to transmit data can be protected from being transmitted to the external.

### TECHNICAL FIELD

The present invention relates to a security apparatus and method for a USB keyboard capable of effectively preventing data input by a malicious program from being intercepted and stolen, wherein the data is input from a keyboard in communication with a main body of a personal computer (PC) through USB to transmit data.

### BACKGROUND ART

With the recent development of the internet, data leakage from PCs frequently occurs. Such data leakage occurs in two steps, including data collection and data leakage, which is prevented by anti-spyware programs, anti-virus programs or firewalls. However, to protect against a novel hacking tool, the hacking tool has to be collected, analyzed and patched, and thus it seems that data may be defenseless until the patch is implemented.

For this reason, it is necessary to have technology to prevent the leakage of personal data from when data is input using a keyboard. While many keyboards have been developed using PS/2, a USB keyboard is currently popular because it is easily installed and the computer does not need to reboot.

Such a USB keyboard is connected to exchange messages with an operating system while communication is performed between a main body of the computer and peripheral devices by the flow of packets containing multiple data, not a simple electrical signal flow.

However, as the leakage of personal data increasingly occurs by taking advantage of internet weaknesses, USB keyboard security issues have become serious, not only in the office, but also in the home. The exposure of personal data during registration to websites and when using passwords for internet banking is frequent.

### DISCLOSURE OF INVENTION

### Technical Problem

The present invention is directed to a security apparatus and method for a USB keyboard, capable of effectively preventing data input by a malicious program from being intercepted and stolen, wherein the data is input from a keyboard in communication with a main body of a personal computer (PC) through USB to transmit data.

### Technical Solution

A first aspect of the present invention provides a data security apparatus for a USB keyboard including: a USB keyboard security driver for selecting a driver for a USB keyboard from USB devices connected to a personal computer, and replacing a data processing function address in a USB hub driver with a function address of the selected USB keyboard driver to acquire input data input by the USB keyboard; a USB keyboard data processing module for preferentially receiving the input data acquired from the USB keyboard security driver, and processing the input data through analysis, encoding and deletion processes; and a USB keyboard data transfer module for decoding the input data processed by the USB keyboard data processing module and outputting the decoded input data to a user's desired location.

Here, the USB keyboard data processing module may include: a data receiving part for preferentially receiving the input data acquired from the USB keyboard security driver; a data analyzing part for analyzing input data to be protected of the input data received from the data receiving part; a data encoding part for encoding the input data to be protected which is analyzed in the data analyzing part; and a data deleting part for deleting the input data to be protected of the input data received from the data receiving part not to be recognized by an operating system.

The USB keyboard data transfer module may include: a data decoding part for decoding the input data encoded by the USB keyboard data processing module to be processed by the operating system; and a data input part for outputting the input data decoded in the data decoding part to a user's desired location.

A second aspect of the present invention provides a data security method for a USB keyboard including: (a) selecting a driver for the USB keyboard; (b) replacing a data processing function address in a USB hub driver included in a kernel region with a function address of the USB keyboard driver; (c) preferentially receiving input data input by manipulating the USB keyboard, and processing input data to be protected through analysis, encoding and deletion processes; and (d) decoding the encoded input data to be protected and outputting the decoded input data to a user's desired location.

Here, step (a) may include the sub-steps of: (a-1) acquiring a list of device objects of the USB hub driver; (a-2) selecting device objects whose member variables are not NULL from the device objects acquired in sub-step (a-1); (a-3) acquiring a list of device objects connected to an HID class driver from the device objects selected in sub-step (a-2); and (a-4) acquiring a list of device objects related to an HID keyboard from the device objects acquired in sub-step (a-3).

In sub-step (a-1), the list of the driver objects may be acquired by repeatedly performing a first process of obtaining the driver objects of the USB hub driver, a second process of obtaining a pointer of a first device object from the member variables that the driver objects have, and a third process of obtaining a pointer of a next device object from the member variables of the device objects.

In sub-step (a-3), if a member variable of one of the device objects selected in sub-step (a-2) is the same as a pointer of a driver object of the HID class driver, it may be determined that the one of the selected device objects is connected to the HID class driver.

In sub-step (a-4), the HID keyboard may be verified using descriptors of the device objects acquired in sub-step (a-3).

Step (c) may include the sub-steps of: (c-1) preferentially receiving input data input by manipulating the USB keyboard; (c-2) analyzing input data to be protected among the input data received in sub-step (c-1); (c-3) encoding the input data to be protected analyzed in sub-step (c-2); and (c-4) deleting the input data to be protected among the input data received in sub-step (c-1) not to be recognized by an operating system.

A third aspect of the present invention provides a computer-readable recording medium storing a program which can execute the above described data security methods for a USB keyboard using a computer.

### Advantageous Effects

According to a security apparatus and method for a USB keyboard described above, it is possible to prevent data input by a malicious program from being intercepted and stolen, wherein the data is input from a keyboard in communication with a main body of a personal computer (PC) through USB to transmit data.

### BRIEF DESCRIPTION OF THE DRAWINGS

FIG. 1 is an overall block diagram of the structure of a USB driver including a security apparatus for a USB keyboard according to an exemplary embodiment of the present invention;

FIG. 2 illustrates a connection structure between a USB hub driver and an HID class driver of FIG. 1;

FIG. 3 is an overall flow chart illustrating a security method for a USB keyboard according to an exemplary embodiment of the present invention; and

FIG. 4 illustrates a process of acquiring a list of device objects included in a USB hub driver.

### MODE FOR THE INVENTION

Hereinafter, exemplary embodiments of the present invention will be described in detail. However, the present invention is not limited to the exemplary embodiments disclosed below, but can be implemented in various ways. Therefore, the present exemplary embodiments are provided for the complete disclosure of the present invention and to fully inform the scope of the present invention to those ordinarily skilled in the art.

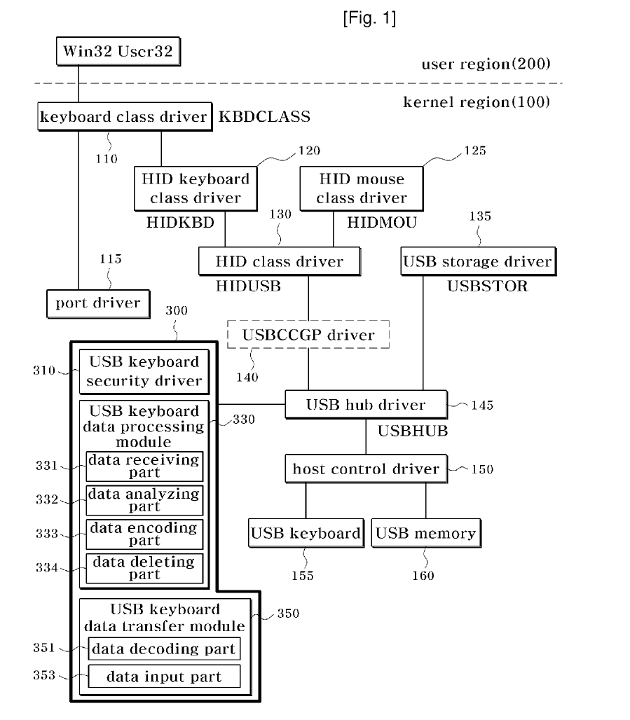

FIG. 1 is an overall block diagram of the structure of a USB driver including a security apparatus for a USB keyboard according to an exemplary embodiment of the present invention.

Referring to FIG. 1, a USB driver including a security apparatus for a USB keyboard according to an exemplary embodiment of the present invention is divided into a kernel region 100 and a user region 200.

Here, the kernel region 100 is the most important part of a computer operating system, which provides several basic services to all different parts of the operating system, and thus may also be called a “nucleus.”

The kernel region 100 basically includes a keyboard class driver 110, a port driver 115, an HID keyboard class driver 120, an HID mouse class driver 125, an HID class driver 130, a USB storage driver 135, a USBCCGP driver 140, a USB hub driver 145, a host control driver 150, a USB keyboard 155 and a USB memory 160.

Meanwhile, the user region 200 is located at the most outer part of the operating system, and serves to process a user's order. The user region 200 may also be called a cell.

In particular, in order to protect data input by the USB keyboard 155, a USB keyboard security apparatus 300 according to an exemplary embodiment of the present invention is installed in the USB hub driver 145 in the kernel region 100.

Operations of processing the data input by the USB keyboard 155 in the operating system without installation or activation of the USB keyboard security apparatus 300 are as follows.

First, the USB keyboard 155 is connected to a personal computer (PC), and a driver suitable for a corresponding device sends a WM_DEVICECHANGE message to an application which is being loaded and operated to conduct a necessary operation with respect to the new device.

Then, the completely installed USB keyboard 155 is sequentially connected with driver devices such as the host control driver 150, the USB hub driver 145, the USBCCGP driver 140 and the HID class driver 130.

Here, the host control driver 150 is connected with a physical USB device. For example, the host controller device 150 is composed of a host controller class driver (usbd.sys) and two miniclass drivers (uhcd.sys and openhci.sys) in Windows 2000, and supports USB 2.x and is composed of a host controller driver (usbport.sys) and three miniport drivers (usbuhci.sys, usbohci.sys and usbehci.sys) in Windows XP.

The USB hub (BUS) driver (USBHub.sys) 145 serves to distribute data input from the physical USB device into corresponding client device drivers.

Here, the main client device driver includes, for example, an audio speaker, a communication modem, a human input device (HID; a device for directly inputting data to a computer by a user. e.g., a keyboard, a mouse, a joystick, etc.), a display (a monitor), a physical feedback device (a POS feedback joystick), power (an uninterruptible power supply system), a printer, a mass storage device (a hard drive) and a hub.

The USB common class generic parent driver (USBCCGP; USBccgy.sys) 140 effectively processes a composite USB device (a device having at least two functions by one USB connection) in Windows XP.

The HID class/miniclass driver (HIDUSB; HIDUSB.sys and HIDClass.sys) 130 sends the USB data input from the HID device to a corresponding class driver, and the corresponding class driver processes the data and transfers it to the operating system.

Here, the keyboard data is transferred to the keyboard class driver (KBDCLASS; kbdclass.sys) 110 through the HID keyboard class driver (HIDKBD; kbdhid.sys) 120.

More specifically, all data of the USB device goes to upper-level drivers through the USB hub driver 145. Here, when the connected USB device is an HID device, the data goes to the HID class driver 130, and when the connected USB device is a storage device, it goes to the USB storage driver (usbstor.sys) 135.

For example, if the operating system is Windows XP and the connected HID USB device is a composite USB device, the data goes from the USB hub driver 145 to the HID class driver 130 via the USBCCGP driver 140.

Furthermore, the HID class driver 130 is connected to the HID keyboard class driver 120 or an HID mouse class driver (MOUHID) 125 depending on the kind of the device, for example, a keyboard, a mouse or a joystick.

The HID keyboard class driver 120 is connected to the keyboard class driver (KBDCLASS) 110 which is also connected to a port driver 115 for a PS/2 keyboard.

Here, the port driver 115 is an i8042 port driver which is widely used, and serves to process input data through an input data path set by an interrupt handler (not illustrated).

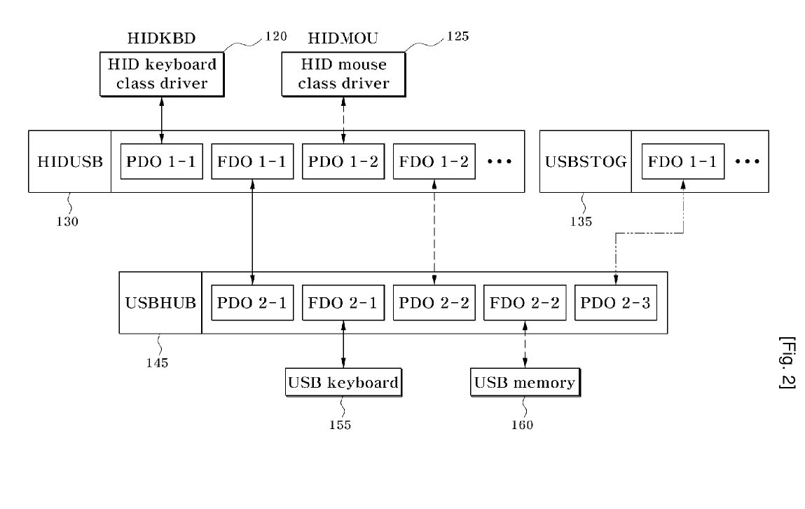

FIG. 2 illustrates a connection structure between the USB hub driver and the HID class driver of FIG. 1.

Referring to FIG. 2, a driver object used for input/output (I/O) such as the USB hub driver 145 or the HID class driver 130 generally has a physical device object (PDO) and a functional device object (FDO).

Here, the PDO is a device object for realizing a main function of the driver, and the FDO is a device object for transferring data to a lower level driver in the form of an I/O request packet (IRP).

Each driver object has a PDO and an FDO, thereby being connected to a next level driver object.

That is, when the USB keyboard 155 is connected to the PC, the operating system transfers a USB request block (URB), i.e., a structure for receiving keyboard data, to the host control driver 150 as a parameter with respect to the IRP.

Further, when the USB keyboard 155 is pressed and keyboard input data occurs, the keyboard input data is recorded in the URB, and then transferred to the operating system after IRP completion.

After that, the operating system which has processed the keyboard input data sends the URB in order to receive the next keyboard input data, and waits for the USB keyboard 155 to be pressed again. That is, the IRP generated in the operating system is not transferred to the host control driver 150.

Meanwhile, the IRP generated in the operating system is transferred to a PDO of a right lower level driver, the PDO generates a new IRP to conduct an IRP operation requested from the operating system, and the new IRP is transferred to a PDO of a right lower level driver by an FDO. According to the function of each driver, the driver may have a PDO or an FDO only.

The USB keyboard security apparatus 300 according to the exemplary embodiment of the present invention which is installed at the USB hub driver 145 in the kernel region 100 to protect the data input from the USB keyboard 155 will now be described in detail.

That is, the USB keyboard security apparatus 300 according to the exemplary embodiment of the present invention includes a USB keyboard security driver 310, a USB keyboard data processing module 330 and a USB keyboard data transfer module 350.

Here, the USB keyboard security driver 310 serves to select a driver for the USB keyboard 155 from the USB devices connected to the PC, and replace a data processing function address in the USB hub driver 145 with a function address of the selected USB keyboard 155 driver to acquire the data input through the USB keyboard 155.

The USB keyboard data processing module 330 preferentially receives the input data acquired from the USB keyboard security driver 310, and processes the input data through analysis, encoding and deletion processes.

The USB keyboard data processing module 330 includes a data receiving part 331 for preferentially receiving the input data acquired by the USB keyboard security driver 310, a data analyzing part 332 for analyzing input data to be protected among the input data received from the data receiving part 331, a data encoding part 333 for encoding the input data to be protected analyzed in the data analyzing part 332, and a data deleting part 334 for deleting the input data to be protected among the input data received from the data receiving part 331 not to be recognized by the operating system.

The USB keyboard data transfer module 350 decodes the input data processed by the USB keyboard data processing module 330 and outputs the decoded input data to a desired location.

The USB keyboard data transfer module 350 includes a data decoding part 351 for decoding the input data encoded by the USB keyboard data processing module 330 to be processed by the operating system, and a data input part 353 for outputting the input data decoded in the data decoding part 351 to a desired location.

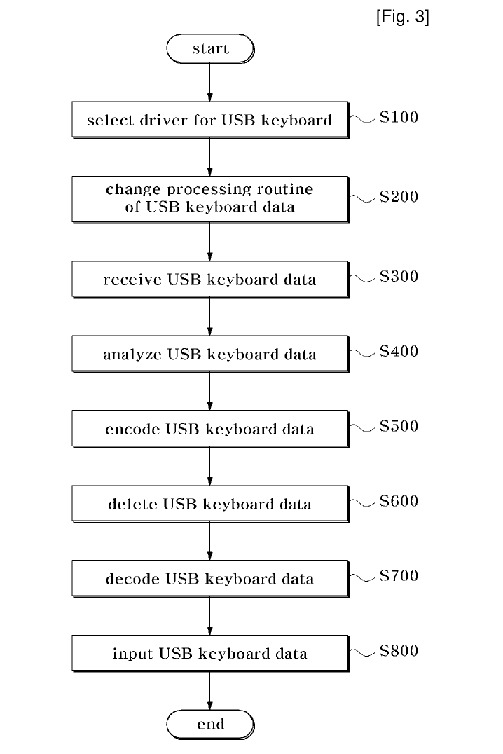

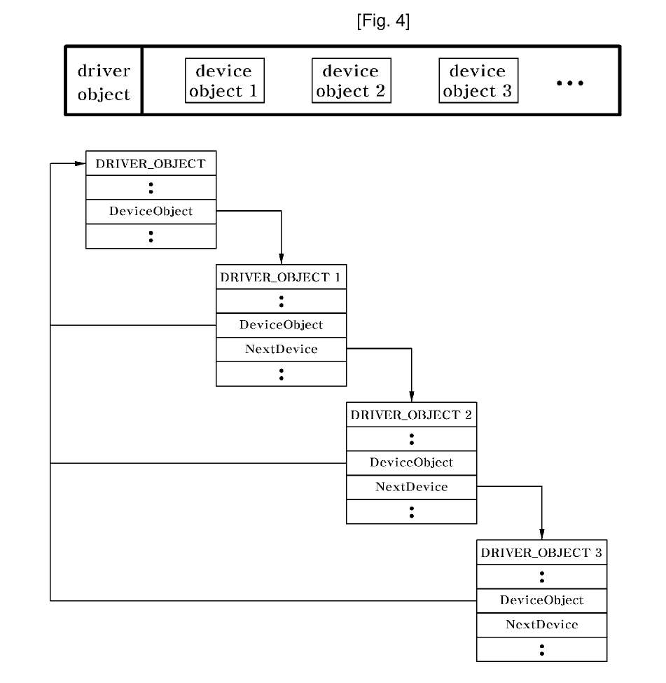

FIG. 3 is an overall flow chart illustrating a security method for a USB keyboard according to another exemplary embodiment of the present invention, and FIG. 4 illustrates a process of acquiring a list of device objects included in a USB hub driver.

Referring to FIGS. 3 and 4, a driver for the USB keyboard 155 (see FIG. 1) is first selected by the USB keyboard security driver 310 (see FIG. 1) (S100).

That is, in step S100, first, a list of device objects included in the USBHUB 145 is acquired. More specifically, after obtaining the driver object of the USBHUB 145, a pointer of a first device object may be obtained from a member variable of the driver object, and then a pointer of a next device object may be obtained from a member variable of the first device object. In this manner, the list of all device objects (PDO 2-1, FDO 2-1, PDO 2-2, FDO 2-2 and PDO 2-3) included in the USBHUB 145 can be acquired.

Second, from the device objects included in the USBHUB 145, device objects (PDO 2-1, PDO 2-2 and PDO 2-3) whose member variables are not NULL are selected.

Third, from the selected device objects, a list of device objects (PDO 2-1, PDO 2-2) connected to the HID class driver (HIDUSB) 130 is acquired. That is, when a member variable of one of the selected device objects is the same as a pointer of a driver object of the HIDUSB 130, it is determined that the one is connected to the HIDUSB 130.

Fourth, from the acquired device objects, a list of device objects (PDO 2-1) related to an HID keyboard is acquired. That is, the HID keyboard is identified by descriptors of the acquired device objects.

In more technical terms, the input data of the USB keyboard 155 has to be as close to a physical device as possible to be protected. For instance, the USBHUB 145 in Windows 2000 has several PDOs and FDOs.

Data coming through the FDO of the USBHUB 145 is received from all types of USB device, for example, a keyboard, a mouse and a joystick storage device. It is not easy to select and protect only keyboard data among a large amount of data.

The PDOs of the USBHUB 145 are classified into an HID device and a storage device according to which any driver object of the HIDUSB 130 and the USBSTOR 135 (see FIG. 1) is connected to the PDOs of the USBHUB 145.

The HID devices are connected to the FDOs of the HIDUSB 130 and the PDOs of the USBHUB 145, respectively, so that the keyboard data is received by the PDO of the USBHUB 145 related to the USB keyboard 155.

For instance, if, in Windows XP, a USB device is a composite device, the USBCCGP driver 140 (see FIG. 1) is disposed between the USBHUB 145 and the HIDUSB 130. That is, when a wireless keyboard and a wireless mouse use one USB receiver, USB wireless keyboard and mouse data are transferred to one FDO of the USBCCGP 140, and the PDOs of the USBCCGP driver 140 are assigned to the keyboard and the mouse and connected to the FDOs of the HIDUSB 130, respectively, so that the keyboard data and the mouse data are classified, and then transferred to the HIDUSB 130.

For this reason, in Windows 2000, a PDO for transferring the keyboard data has to be located in the PDOs of the USBHUB 145, and, in Windows XP, a PDO for transferring the keyboard data has to be located in the PDOs of the USBHUB 145 and the USBCCGP driver 140.

While the invention will be described hereinafter with reference to the USBHUB 145, it is to be understood that the USBCCGP 140 is also treated in the same manner as the USBHUB 145.

Acquiring a PDO that transfers data of the USB keyboard 155 uses the following process.

First, a DEVICE_OBJECT (a structure having data of a device object) list of the USBHUB 145 is obtained. That is, in order to obtain the USBHUB 145, a pointer of DRIVE_OBJECT is acquired using an ObReferenceObjectByName( ) function and the name of “\\Driver\\usbhub.” A DeviceObject item of the DRIVER_OBJECT is a pointer of the DRIVER_OBJECT of a first device object.

Moreover, device objects are connected to each other by chains, and a DEIVCE_OBJECT.NextDevice item is a pointer of DEVICE_OBJECT of a next device object. In this manner, all DEVICE_OBJECTs of the device objects in the USBHUB 145 can be acquired.

Second, PDOs are selected from the DEVICE_OBJECTs. That is, as described above, the PDO of the USBHUB 145 and the FDO of the HIDUSB 130 are connected to each other, thereby exchanging data. To be exact, it can be said that the FDO of the HIDUSB 130 is attached to the PDO of the USBHUB 145.

Among the DEVICE_OBJECTs of the USBHUB 145 acquired above, device objects in which DEVICE_OBJECT.AttachedDevice is not NULL are PDOs. Here, the DEVICE_OBJECT.AttachedDevice is a pointer of the DEVICE_OBJECT of the device object attached to a corresponding device object.

Third, a device object of the USBHUB 145 connected to the HID device is acquired. That is, DEVICE_OBJECT.DriveObject of the device object acquired from the DEVICE_OBJECT.AttachedDevice denotes a DRIVER_OBJECT pointer of a driver object having the device object. It can be seen from the comparison between this value (pointer) and the pointer of DRIVER_OBJECT of the HIDUSB 130 whether a device object of the USBHUB 145 is or is not attached to the HID driver.

Here, to obtain the DRIVER_OBJECT of the HIDUSB 130, the name of the HIDUSB 130 is used, but is not always the same as the original. When the USB keyboard 155 is simply connected to the PC, the driver name is the same. However, when a keyboard driver provided from the USB keyboard 155 is installed to use functions provided therefrom, the name of the HIDUSB 130 may be changed. Thus, the driver objects installed in the PC are referred to in order to acquire the driver object connected to the HIDKBD 120, which will be identified with the HIDUSB 130.

Fourth, a device object of the USBHUB 145 related to the keyboard connected to the HID device is acquired. That is, the USB device has a descriptor for recognizing what the device is. URB for obtaining a descriptor of USB_CONFIGURATION_DESCRIPTOR_TYPE is generated using an USBBuild-GetDescriptorRequest function.

Attaching the URB as a parameter of a stack location of I/O Code: IOCTL_INTERNAL_USB_SUBMIT_URB (IRP), the URB is sent to the PDO of the driver object of the USBHUB 145 selected above (IoCallDriver) in order to acquire a descriptor of the device connected to the PDO. The USB keyboard 155 is verified by the descriptor acquired in such a manner through an USBD_ParseConfigurationDescriptorEx function. In the case of the USB keyboard 155, the result of the USBD_ParseConfigurationDescriptorEx function may be the return of a pointer of a USB_INTERACE_DESCRIPTOR structure denoting an interface for providing the function of the USB keyboard 155.

Next, a processing routine of the USB keyboard 155 data is changed by the USB keyboard security driver 310 (S200). That is, a data processing function address in the USBHUB 145 included in a kernel region 100 is replaced by a function address of the USB keyboard 155 driver.

In more technical terms, data of the USB keyboard 155 is filled in the URB attached as the parameter of the IRP received from the HIDUSB 130, and then transmitted to the HIDUSB 130 again.

Here, a major function table is a table in which a routine processing the data according to the I/O code of the IRP transmitted to the HIDUSB 130 is defined. To obtain the USB keyboard 155 data, the HIDUSB 130 uses I/O Code IRP_MJ_INTERNAL_DEVICE_CONTROL, and an address of the major function processing IRP_MJ_INTERNAL_DEVICE_CONTROL of the USBHUB 145 is replaced by a security keyboard service routine address.

After that, the USB keyboard data processing module 330 processes input data to be protected after preferentially receiving input data which is input by manipulating the USB keyboard 155, and performing analysis, encoding and deletion (S300 to S500).

That is, the input data input by manipulating the USB keyboard is preferentially received (S300). In more technical terms, the security keyboard service routine receives all IRP_MJ_INTERNAL_DEVICE_CONTROL IRPs coming to the USBHUB 145. If the IRP is for the USB keyboard 155 data, a pointer of DEVICE_OBJECT transferred as a parameter of the security keyboard service routine is the same as the DEVICE_OBJECT of the PDO of the USBHUB 145 for the USB keyboard 155 selected above.

The USB keyboard 155 data is pending while the IRP having the URB is down. Then, when the data of the USB keyboard 155 occurs, the data is filled in the URB and calls a completion routine which is set in the IRP. Thus, the completion routine set in the IRP to obtain the data of the USB keyboard 155 is replaced by a security keyboard completion routine, and thereby the data of the USB keyboard 155 can be processed first.

Then, the input data to be protected is analyzed among the input data received in step S300 (S400). That is, the data of the USB keyboard 155 goes up by 8 bytes at a time. Among such data, a keyboard data to be protected is selected, and has to be analyzed because it is different from that of PS/2.

For instance, in DOWN and UP keys on a keyboard, the data of the USB keyboard 155 is transferred by storing a keyboard s state in the URB whenever it changes. Upon pressing a ‘A’ key, the ‘A’ key-pressed data goes up, and upon releasing the ‘A’ key, the ‘A’ key-released data goes up. On a PS/2 keyboard, upon pressing the ‘A’ key, ‘A’ down data occurs until the ‘A’ key is released, and then ‘A’ Up data occurs. However, the USB keyboard 155 data occurs once when the key is pressed and released.

Meanwhile, in the event of two keyboard inputs, when the key is input in order of ‘A’ down, ‘B’ down, ‘A’ up and ‘B’ up, signals that ‘A’ is pressed, ‘A’ and ‘B’ are pressed, ‘B’ is pressed and no key is pressed sequentially occur.

After that, the input data to be protected that is analyzed in step S400 is encoded (S500), and the data to be protected of the input data received in step S300 is deleted not to be recognized by the operating system (S600).

That is, in step S500, the data is subjected to 128 bit encoding in order to safely transmit the USB keyboard 155 to an application module. In step S600, only the data to be protected is selected from the keyboard data and then deleted such that the operating system does not receive the keyboard data received from the security keyboard service routine.

Finally, the USB keyboard data transfer module 350 decodes the input data to be protected which is encoded in step S500 (S700), and then outputs it to a desired location (S800).

Additionally, when several USB keyboards 155 are connected, PDOs of the USBHUB 145 corresponding to the respective USB keyboards 155 are generated and connected thereto. Thus, a DEVICE_OBJECT pointer list of PDOs related to the USB keyboard 155 among the PDOs of the USBHUB 145 is acquired, and then compared with the DEVICE_OBJECT pointer transferred as a parameter when the security keyboard service routine is called, thereby easily supporting security of the several USB keyboards 155.

Furthermore, service routine addresses of the Major Function Table of the USBHUB 145 are periodically monitored, and if there is any change, the USBHUB 145 is restored to its original (normal) state, and a hacking driver's name is detected using the service routine address used in the hacking and may be notified to the user.

Meanwhile, the security method for the USB keyboard according to the exemplary embodiment of the present invention can also be realized by a code written to a computer-readable recording medium which can be read by a computer. The computer-readable recording media may include all types of recording devices in which computer-readable data can be stored.

For example, the computer-readable recording media may include a ROM, a RAM, a CD-ROM, a magnetic tape, a hard disk, a floppy disk, a portable storage device, a flash memory, and an optical data storage device, and also include a carrier wave type device (e.g., transmission via the Internet).

Also, the computer-readable recording media are distributed to the computer system, which is connected to the media using a computer network, and thus may be stored as codes which are readable in a distribution method and executed.

While a security apparatus and method for a USB keyboard according to the present invention have been shown and described with reference to certain exemplary embodiments thereof, it will be understood by those skilled in the art that various changes in form and details may be made therein without departing from the spirit and scope of the invention as defined by the appended claims.

1. A data security apparatus for a USB keyboard, comprising:
a USB keyboard security driver for selecting a driver for a USB keyboard from USB devices connected to a personal computer, and replacing a data processing function address in a USB hub driver with a function address of the selected USB keyboard driver to acquire input data input by the USB keyboard;
a USB keyboard data processing module for preferentially receiving the input data acquired from the USB keyboard security driver, and processing the input data through analysis, encoding and deletion processes; and
a USB keyboard data transfer module for decoding the input data processed by the USB keyboard data processing module and outputting the decoded input data to a user's desired location.

2. The apparatus according to claim 1, wherein the USB keyboard data processing module comprises:
a data receiving part for preferentially receiving the input data acquired from the USB keyboard security driver;
a data analyzing part for analyzing input data to be protected of the input data received from the data receiving part;
a data encoding part for encoding the input data to be protected which is analyzed in the data analyzing part; and
a data deleting part for deleting the input data to be protected of the input data received from the data receiving part not to be recognized by an operating system.

3. The apparatus according to claim 1, wherein the USB keyboard data transfer module comprises:
a data decoding part for decoding the input data encoded by the USB keyboard data processing module to be processed by the operating system; and
a data input part for outputting the input data decoded in the data decoding part to a user s desired location.

4. A data security method for a USB keyboard, comprising the steps of:
(a) selecting a driver for the USB keyboard;
(b) replacing a data processing function address in a USB hub driver included in a kernel region with a function address of the USB keyboard driver;
(c) preferentially receiving input data input by manipulating the USB keyboard, and processing input data to be protected through analysis, encoding and deletion processes; and
(d) decoding the encoded input data to be protected and outputting the decoded input data to a user s desired location.

5. The method according to claim 4, wherein step (a) comprises the sub-steps of:
(a-1) acquiring a list of device objects of the USB hub driver;
(a-2) selecting device objects whose member variables are not NULL from the device objects acquired in sub-step (a-1);
(a-3) acquiring a list of device objects connected to an HID class driver from the device objects selected in sub-step (a-2); and
(a-4) acquiring a list of device objects related to an HID keyboard from the device objects acquired in sub-step (a-3).

6. The method according to claim 5, wherein, in sub-step (a-1), the list of the driver objects is acquired by repeatedly performing a first process of obtaining the driver objects of the USB hub driver, a second process of obtaining a pointer of a first device object from the member variables that the driver objects have, and a third process of obtaining a pointer of a next device object from the member variables of the device objects.

7. The method according to claim 5, wherein, in sub-step (a-3), if a member variable of one of the device objects selected in sub-step (a-2) is the same as a pointer of a driver object of the HID class driver, it is determined that the one of the selected device objects is connected to the HID class driver.

8. The method according to claim 5, wherein, in sub-step (a-4), the HID keyboard is verified using descriptors of the device objects acquired in sub-step (a-3).

9. The method according to claim 4, wherein step (c) comprises the sub-steps of:
(c-1) preferentially receiving input data input by manipulating the USB keyboard;
(c-2) analyzing input data to be protected among the input data received in sub-step (c-1);
(c-3) encoding the input data to be protected analyzed in sub-step (c-2); and
(c-4) deleting the input data to be protected among the input data received in sub-step (c-1) not to be recognized by an operating system.

10. A computer-readable recording medium storing a program which can execute the method according to any one of claims 4 to 9 using a computer.
